(19) United States
(12) Patent Application Publication
(10) Pub. No.: US 2020/0317181 A1
(43) Pub. Date: Oct. 8, 2020

(54) Vehicle, Electronic Parking Brake System and Control Method Thereof

(71) Applicant: GUANGZHOU AUTOMOBILE GROUP CO., LTD., Guangzhou, Guangdong (CN)

(72) Inventors: Jiantao SUN, Guangzhou, Guangdong (CN); Zhenwen CHEN, Guangzhou, Guangdong (CN); Lang LIU, Guangzhou, Guangdong (CN); Dongxu YI, Guangzhou, Guangdong (CN); Chunhui PEI, Guangzhou, Guangdong (CN)

(73) Assignee: Guangzhou Automobile Group Co., Ltd., Guangzhou, Guangdong (CN)

(21) Appl. No.: 16/099,430

(22) PCT Filed: Jan. 19, 2018
(86) PCT No.: PCT/CN2018/073361

§ 371 Date: Nov. 6, 2018

(30) Foreign Application Priority Data
Jan. 21, 2017 (CN) 201710051921.4

(51) Int. Cl. B60T 17/22; B60T 13/74

(52) U.S. Cl. CPC B60T 17/221; B60T 13/74; B60T 2201/06; B60Y 2400/305; B60Y 2400/81; B60Y 2400/303

(57) ABSTRACT

Provided are a vehicle, an electronic parking brake system and a control method thereof. The control method includes: controlling, when the electronic parking brake system is started, an electronic parking clamping force to be equal to a first preset value to perform parking braking on the vehicle; detecting the electronic parking clamping force and a current state of the vehicle; and when detecting that the vehicle moves, adjusting the electronic parking clamping force according to a magnitude relationship between the electronic parking clamping force and the first preset value to perform the parking braking on the vehicle again.

### TECHNICAL FIELD

The present disclosure belongs to the technical field of vehicle braking, and more particularly, to a vehicle, an electronic parking brake system and a control method thereof.

### BACKGROUND

In the technical field of vehicles, a driving brake system and a parking brake system are provided. A part of components may be shared by the two systems. The driving brake system includes a booster, a clamp and a brake disc, and is configured to decelerate a vehicle or stop the vehicle temporarily. The parking brake system includes a handbrake, a footbrake and an electronic parking brake, and is configured to keep the vehicle stationary when the vehicle stops.

An operation system of the parking brake system includes an electronic parking brake system and a mechanical parking brake system. With regard to a parking brake system of a limousine, electronic parking brake system is generally adopted instead of conventional mechanical parking brake system. When the vehicle needs to stop temporarily or needs to park for a long time, an electronic parking brake switch of the electronic parking brake system is turned on, so that the vehicle is in a stopped state. When the vehicle drives again, the electronic parking brake switch of the electronic parking brake system is turned off, so that the vehicle can drive normally.

However, when the vehicle stops on a slope, even if the electronic parking brake switch is turned on to make the electronic parking brake statically clamped, there is still a risk that the vehicle slides down the slope.

### SUMMARY

Some embodiments of the present disclosure provide an electronic parking brake system and a control method thereof, which may solve a problem that when a vehicle stops on a slope, there is a risk that the vehicle slides down the slope even if an electronic parking brake switch is turned on to make the electronic parking brake statically clamped in a related technology.

An embodiment of the present disclosure provides a control method for an electronic parking brake system, which may include the following acts.

When the electronic parking brake system is started, an electronic parking clamping force is controlled to be equal to a first preset value to perform parking braking on a vehicle.

The electronic parking clamping force and a current state of the vehicle are detected.

When it is detected that the vehicle moves, the electronic parking clamping force is adjusted according to a magnitude relationship between the electronic parking clamping force and the first preset value to perform the parking braking on the vehicle again.

Another embodiment of the present disclosure provides an electronic parking brake system, which may include a control unit, a vehicle state detection unit and a clamping force detection unit.

The control unit is configured to control, when an electronic parking brake is started, an electronic parking clamping force to be equal to a first preset value to perform parking braking on a vehicle.

The vehicle state detection unit is configured to detect a current state of the vehicle.

The clamping force detection unit is configured to detect the electronic parking clamping force.

The control unit is configured to adjust, when the vehicle state detection unit detects that the vehicle moves, the electronic parking clamping force according to a magnitude relationship between the electronic parking clamping force and the first preset value to perform the parking braking on the vehicle again.

Still another embodiment of the present disclosure provides a vehicle, which may include the electronic parking brake system provided by the above embodiment.

According to the vehicle, the electronic parking brake system and the control method thereof, when the vehicle parks, a electronic parking clamping force is controlled to be equal to a first preset value to perform parking braking on the vehicle, the electronic parking clamping force and a current state of the vehicle are monitored, and when it is detected that the vehicle moves, the electronic parking clamping force is adjusted according to a magnitude relationship between the electronic parking clamping force and the first preset value to perform the parking braking on the vehicle again. The electronic parking system can be controlled to provide an enough brake force to park the vehicle, and a problem that when the vehicle stops on a slope, there is a risk that the vehicle slides down the slope even if the electronic parking brake switch is turned on to make the electronic parking brake statically clamped is prevented.

### BRIEF DESCRIPTION OF THE DRAWINGS

In order to describe the technical solutions of the embodiments of the present disclosure more clearly, the drawings required to be used in the embodiments of the present disclosure will be simply introduced below. Obviously, the drawings described below are only some embodiments of the present disclosure. Other drawings may further be obtained by those skilled in the art according to these drawings without creative work.

FIG. 1 is a flowchart of a control method of an electronic parking brake system provided by a first embodiment of the present disclosure.

FIG. 2 is a flowchart of a control method of an electronic parking brake system provided by a second embodiment of the present disclosure.

FIG. 3 is a flowchart of a control method of an electronic parking brake system provided by a third embodiment of the present disclosure.

FIG. 4 is structural schematic diagram of an electronic parking brake system provided by a fourth embodiment of the present disclosure.

FIG. 5 is structural schematic diagram of an electronic parking brake system provided by a fifth embodiment of the present disclosure.

FIG. 6 is structural schematic diagram of an electronic parking brake system provided by a sixth embodiment of the present disclosure.

FIG. 7 is structural schematic diagram of an electronic parking brake system provided by a seventh embodiment of the present disclosure.

### DETAILED DESCRIPTION OF THE EMBODIMENTS

For making the purpose, technical solutions and advantages of the present disclosure clearer, the present disclosure will further be described below in combination with the drawings and embodiments in detail. It should be understood that the specific embodiments described here are adopted only to explain the present disclosure, not to limit the present disclosure. The technical solutions of the present disclosure will be described below with specific embodiments.

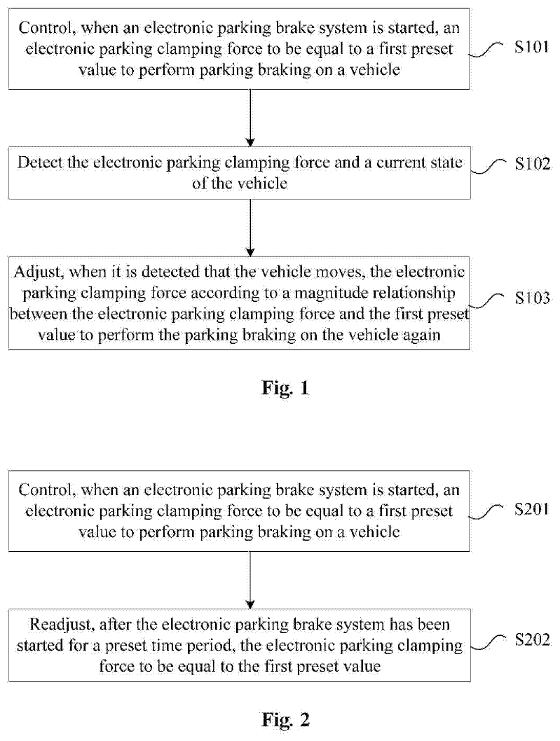

A first embodiment of the present disclosure provides a control method for an electronic parking brake system, which may include the following acts S101 to S103 as shown in FIG. 1.

At act S101, when the electronic parking brake system is started, an electronic parking clamping force is controlled to be equal to a first preset value to perform parking braking on a vehicle.

In this embodiment of the present disclosure, an electronic parking brake may be started by pulling up an electronic parking brake switch. The electronic parking brake system outputs a preset clamping force to stop the vehicle.

At act S102, the electronic parking clamping force and a current state of the vehicle are detected.

In this embodiment of the present disclosure, the detection on the current state of the vehicle is to detect whether the vehicle is in a stationary state or a moving state. Specifically, the detection on the current state of the vehicle may be implemented by arranging a wheel speed sensor to detect whether a wheel has a rotational motion or not.

In this embodiment of the present disclosure, the electronic parking clamping force for stopping the vehicle may change in the process of being applied continuously. For example, when the vehicle is on a slope, the electronic parking clamping force may be gradually reduced. Therefore, it is suggested to detect the electronic parking clamping force in real time. Specifically, the electronic parking clamping force may be detected by arranging a force sensor in the vehicle.

At act S103, when it is detected that the vehicle moves, the electronic parking clamping force is adjusted according to a magnitude relationship between the electronic parking clamping force and the first preset value to perform the parking braking on the vehicle again.

In this embodiment of the present disclosure, when it is detected that the vehicle moves, it is indicated that the vehicle cannot be maintained in a stopped state via the applied electronic parking clamping force. Under such a condition, the electronic parking clamping force needs to be adjusted to stop the vehicle. In the process that the electronic parking clamping force is adjusted, different electronic parking clamping forces are output according the magnitude relationship between the electronic parking clamping force and the first preset value, so as to perform the parking braking on the vehicle again in this act.

Herein, as an implementation manner for adjusting the electronic parking clamping force, adjusting the electronic parking clamping force according the magnitude relationship between the electronic parking clamping force and the first preset value includes the following act.

When the electronic parking clamping force is smaller than the first preset value, the electronic parking clamping force is adjusted to be equal to the first preset value.

Specifically, when the vehicle moves and it is detected that the electronic parking clamping force is smaller than the first preset value, the electronic parking brake is clamped again to prevent the vehicle from moving on. For example, when the vehicle stops on the slope and after the electronic parking brake is statically clamped, the electronic parking clamping force may be weakened or the electronic parking clamping force may be failed and thus there is a risk that the vehicle slides down the slope. Under such a condition, in a case where the electronic parking brake detects that the vehicle moves and the electronic parking clamping force is reduced, the electronic parking brake is clamped again to eliminate the risk that the vehicle slides down the slope.

Herein, as an implementation manner for adjusting the electronic parking clamping force, adjusting the electronic parking clamping force according the magnitude relationship between the electronic parking clamping force and the first preset value includes the following act.

When the electronic parking clamping force is equal to the first preset value, the electronic parking clamping force is adjusted to be equal to a maximum clamping force.

Specifically, when the vehicle moves and it is detected that the electronic parking clamping force is equal to the first preset value, the electronic parking brake is clamped again and the clamping force is increased to prevent the vehicle from moving on. For example, after the vehicle slides down an overlong slope, the vehicle parks on the slope; since the temperatures of a brake disc and a friction plate are relatively high, the friction coefficient is reduced a lot and there is a risk that the vehicle slides down the slope. Under such a condition, in a case where the electronic parking brake detects that the vehicle moves, the electronic parking brake is increased to the maximum clamping force to eliminate the risk that the vehicle slides down the slope.

According to the control method for the electronic parking brake system provided in the embodiment of the disclosure, when the vehicle parks, the electronic parking brake switch is pulled up so that the electronic parking brake is clamped; by pressing down the electronic parking brake switch, the electronic parking brake is released. When the vehicle parks and the electronic parking brake is statically clamped, under a condition in which the electronic parking brake detects that the vehicle moves and the electronic parking clamping force is reduced, the electronic parking brake is clamped again; and under a condition in which the electronic parking brake detects that the vehicle moves and the electronic parking clamping force is kept at a target value, the electronic parking brake is increased to the maximum clamping force to prevent a risk that the vehicle slides down the slope in a parked state.

Based on the embodiment of the present disclosure, when the vehicle parks, the electronic parking clamping force is controlled to be equal to the first preset value to perform the parking braking on the vehicle, the electronic parking clamping force and a current state of the vehicle are monitored, and when it is detected that the vehicle moves, the electronic parking clamping force is adjusted according to the magnitude relationship between the electronic parking clamping force and the first preset value to perform the parking braking on the vehicle again. The electronic parking system can be controlled to provide an enough brake force to park the vehicle, and a problem that when the vehicle stops on the slope, there is a risk that the vehicle slides down the slope even if the electronic parking brake switch is turned on to make the electronic parking brake statically clamped is prevented.

A second embodiment of the present disclosure provides a control method for an electronic parking brake system, which may include the following acts S201 and S202 as shown in FIG. 2.

At act S201, when the electronic parking brake system is started, an electronic parking clamping force is controlled to be equal to a first preset value to perform parking braking on a vehicle.

This act is the same as the act S101, may be referred to related description on the act S101 for more details and will not be repeated here.

At act S202, after the electronic parking brake system has been started for a preset time period, the electronic parking clamping force is readjusted to be equal to the first preset value.

In this embodiment of the present disclosure, after the electronic parking brake is statically clamped, because of reasons such as the vehicle stops on the slope, the electronic parking clamping force may be weakened or the electronic parking clamping force may be failed. By readjusting the electronic parking clamping force at a preset time interval (period), the electronic parking clamping force is maintained to be equal to the first preset value.

When the vehicle stops on the slope and after the electronic parking brake is statically clamped, the electronic parking clamping force may be weakened or the electronic parking clamping force may be failed and there is a risk that the vehicle slides down the slope. Under such a condition, by readjusting the electronic parking clamping force at a preset time interval (period) based on this embodiment of the present disclosure, the electronic parking clamping force is kept to be equal to the first preset value and the electronic parking brake is clamped again to eliminate the risk that the vehicle slides down the slope.

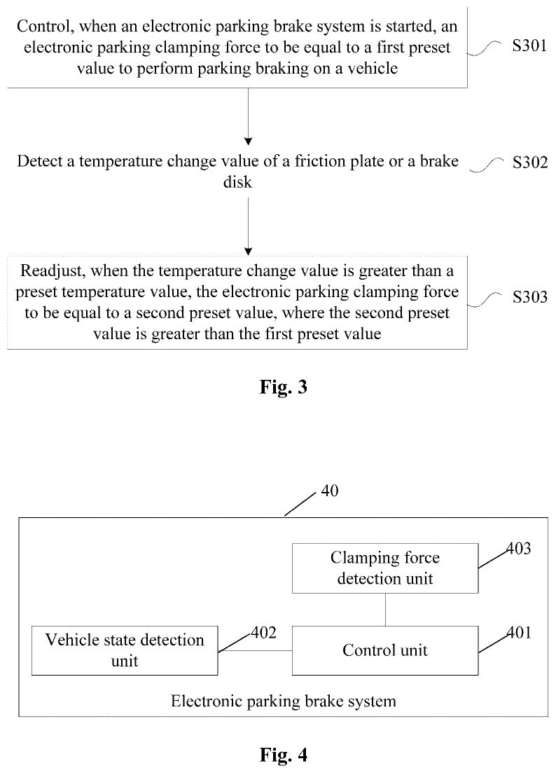

A third embodiment of the present disclosure provides a control method for an electronic parking brake system, which may include the following acts S301 to S303 as shown in FIG. 3.

At act S301, when the electronic parking brake system is started, an electronic parking clamping force is controlled to be equal to a first preset value to perform parking braking on a vehicle.

This act is the same as the act S101, may be referred to related description on the act S101 for more details and will not be repeated here.

At act S302, a temperature change value of a friction plate or a brake disk is detected.

In this embodiment of the present disclosure, after the vehicle slides down an overlong slope, the vehicle parks on the slope; since the temperatures of a brake disc and a friction plate are relatively high, the friction coefficient is reduced a lot. When the brake disc and the friction plate are cooled, because of expansion and contraction, the parking brake cannot be successfully performed on the vehicle even when the electronic parking clamping force is equal to the first preset value, resulting that there is a risk that the vehicle slides down the slope. Therefore, it is suggested to detect the temperature change value of the friction plate or the brake disc and adjust the electronic parking clamping force according to the temperature change value of the friction plate or the brake disc.

At act S303, when the temperature change value is greater than a preset temperature value, the electronic parking clamping force is readjusted to be equal to a second preset value, where the second preset value is greater than the first preset value.

In this embodiment of the present disclosure, when the temperature change value is greater than the preset temperature value, it is indicated that the parking braking cannot be performed on the vehicle via the electronic parking clamping force at this moment and it is suggested to increase the electronic parking clamping force to perform the parking braking on the vehicle again. For example, the electronic parking clamping force may be increased to a maximum clamping force to eliminate the risk that the vehicle slides down the slope.

After the vehicle slides down the overlong slope, the vehicle parks on the slope; since the temperatures of the brake disc and the friction plate are relatively high, the friction coefficient is reduced a lot and there is a risk that the vehicle slides down the slope. Under such a condition, in a case where the electronic parking brake detects that the vehicle moves, the electronic parking brake is increased to the maximum clamping force based on this embodiment of the present disclosure, so as to eliminate the risk that the vehicle slides down the slope.

A fourth embodiment of the present disclosure provides an electronic parking brake system 40, which may include a control unit 401, a vehicle state detection unit 402 and a clamping force detection unit 403, as shown in FIG. 4.

The control unit 401 is configured to control, when an electronic parking brake is started, an electronic parking clamping force to be equal to a first preset value to perform parking braking on a vehicle.

The vehicle state detection unit 402 is configured to detect a current state of the vehicle.

The clamping force detection unit 403 is configured to detect the electronic parking clamping force.

The control unit 401 is configured to adjust, when the vehicle state detection unit 402 detects that the vehicle moves, the electronic parking clamping force according to a magnitude relationship between the electronic parking clamping force and the first preset value to perform the parking braking on the vehicle again.

In this embodiment of the present disclosure, the vehicle state detection unit 402 is configured to detect the current state of the vehicle by detecting whether the vehicle is in a stationary state or a moving state. Specifically, the vehicle state detection unit 402 may be embodied as a wheel speed sensor and may implement the detection on the current state of the vehicle by detecting whether a wheel has a rotational motion.

In this embodiment of the present disclosure, the electronic parking clamping force for stopping the vehicle may change in the process of being applied continuously. For example, when the vehicle is on a slope, the electronic parking clamping force may be gradually reduced, so it is suggested to detect the electronic parking clamping force in real time via the clamping force detection unit 403. Specifically, the clamping force detection unit 403 may be embodied as a force sensor for detecting the electronic parking clamping force.

In this embodiment of the present disclosure, when it is detected that the vehicle moves, it is indicated that the vehicle cannot be maintained in a stopped state via the applied electronic parking clamping force. Under such a condition, the control unit 401 needs to adjust the electronic parking clamping force to stop the vehicle. In the process that the electronic parking clamping force is adjusted, different electronic parking clamping forces are output according the magnitude relationship between the electronic parking clamping force and the first preset value, so as to perform the parking braking on the vehicle again.

Herein, as an implementation manner that the control unit 401 adjusts the electronic parking clamping force, the control unit 401 is configured to adjust, when the electronic parking clamping force is smaller than the first preset value, the electronic parking clamping force to be equal to the first preset value.

Herein, as an implementation manner that the control unit 401 adjusts the electronic parking clamping force, the control unit 401 is configured to adjust, when the electronic parking clamping force is equal to the first preset value, the electronic parking clamping force to be equal to a maximum clamping force.

The specific work process of modules in the electronic parking brake system 40 may be referred to the corresponding processes in the above first method embodiment and will not be repeated here.

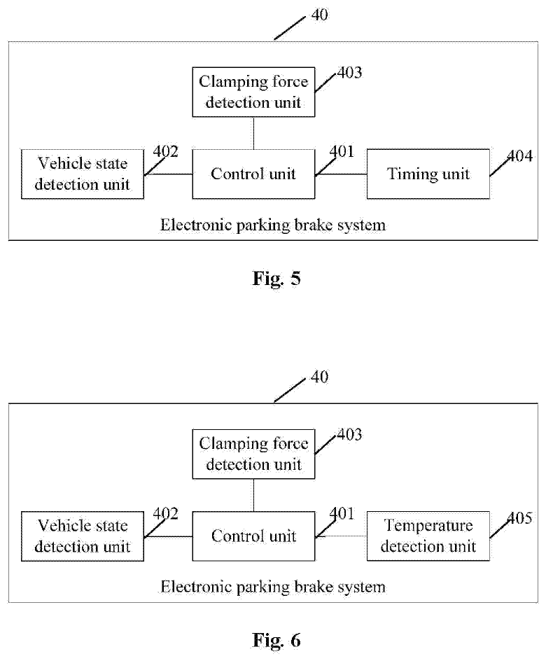

A fifth embodiment of the present disclosure provides an electronic parking brake system 40. As shown in FIG. 5, the electronic parking brake system 40 may further include a timing unit 404 on the basis of the fourth embodiment.

The timing unit 404 is configured to start, when the electronic parking brake system 40 is started, timing.

The control unit 401 is configured to readjust, when a time of the timing unit reaches a preset time, an electronic parking clamping force to be equal to a first preset value.

The specific work process of modules in the electronic parking brake system 40 may be referred to the corresponding processes in the above third method embodiment and will not be repeated here.

A sixth embodiment of the present disclosure provides an electronic parking brake system 40. As shown in FIG. 6, the electronic parking brake system 40 may further include a temperature detection unit 405 on the basis of the fourth embodiment.

The temperature detection unit 405 is configured to detect, when the electronic parking brake system 40 is started, a temperature of a friction plate or a brake disc.

The control unit 401 is configured to readjust, when a temperature change value greater than a preset temperature value, an electronic parking clamping force to be equal to a first preset value.

The specific work process of modules in the electronic parking brake system 40 may be referred to the corresponding processes in the above third method embodiment and will not be repeated here.

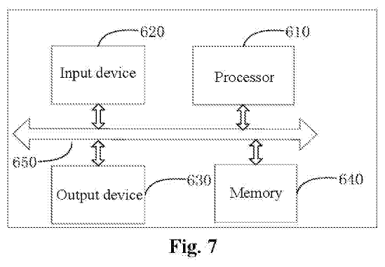

FIG. 7 is a schematic block diagram of an electronic parking brake system provided by a seventh embodiment of the present disclosure. The electronic parking brake system shown in the figure in this embodiment may include one or more processors 610, one or more input devices 620, one or more output devices 630 and a memory 640. The processor 610, the input device 620, the output device 630 and the memory 640 are connected via buses 650.

The memory 640 is configured to store a program instruction.

The processor 610 is configured to execute the following operations according to the program instruction stored by the memory 640.

The processor 610 is configured to control, when the electronic parking brake system is started, an electronic parking clamping force to be equal to, a first preset value to perform parking braking on the vehicle; acquire the electronic parking clamping force and a current state of the vehicle; and adjust, when detecting that the vehicle moves, the electronic parking clamping force according to a magnitude relationship between the electronic parking clamping force and the first preset value to perform the parking braking on the vehicle again.

Further, the processor 610 is further configured to adjust, when the electronic parking clamping force is smaller than the first preset value, the electronic parking clamping force to be equal to the first preset value.

Alternatively, the processor 610 is further configured to adjust, when the electronic parking clamping force is equal to the first preset value, the electronic parking clamping force to be equal to a maximum clamping force.

Alternatively, the processor 610 is further configured to readjust, after the electronic parking brake system has been started for a preset time period, the electronic parking clamping force to be equal to the first preset value.

Alternatively, the processor 610 is further configured to acquire a temperature change value of a friction plate or a brake disc, and adjust, when the temperature change value is greater than a preset temperature value, the electronic parking clamping force to be equal to a second preset value, where the second preset value is greater than the first preset value.

It may be understood that, in this embodiment of the present disclosure, the so-called processor 610 may be a Central Processing Unit (CPU). The processor may further be other universal processor, Digital Signal Processor (DSP), an Application Specific Integrated Circuit (ASIC), a Field-Programmable Gate Array (FPGA) or other programmable logical device, separate gate or transistor logic device, a separate hardware component and the like. The universal processor may be a microprocessor or the processor may also be any conventional processor, etc.

The input device 620 may include a force sensor, a wheel speed sensor and a temperature sensor, etc. The output device 630 may be an execution device which outputs a clamping force and the like.

The memory 640 may include a read-only memory and a random access memory and provide an instruction and data for the processor 610. A part of the memory 640 may further include a non-volatile random access memory. For example, the memory 640 may further store information on a device type.

During specific implementation, the processor 610, the input device 620 and the output device 630 described in this embodiment of the present disclosure may execute the implementations described in the above embodiments of the control method for the electronic parking brake system provided by the embodiments of the present disclosure, and may also execute the implementations of the electronic parking brake system described in the embodiments of the present disclosure, all of which will not be repeated.

An eighth embodiment of the present disclosure provides a vehicle, which may include the above electronic parking brake system.

It should be understood by those skilled in the art that all or part of the acts of the above-mentioned method embodiments may be implemented by instructing related hardware through a program, the above-mentioned program may be stored in a computer-readable storage medium, and the storage medium includes a Read-Only Memory (ROM), a Random Access Memory (RAM), a magnetic disk or an optical disk.

Units/acts in the terminal provided by the embodiments of the present disclosure may be merged, divided and deleted according to an actual demand.

The above are further detailed description of the present disclosure with reference to exemplary implementations and cannot be considered that the specific implementation of the present disclosure is only limited to the description. Those of ordinary skill in the art may make a plurality of equivalent replacements or simple alternations with the same performance or application without departing from the concept of the present disclosure, and all of such equivalent replacements or simple alternations should pertain to the scope of protection of the claims.

What is claimed is:

1. A control method for an electronic parking brake system, the control method comprising:
controlling, when the electronic parking brake system is started, an electronic parking clamping force to be equal to a first preset value to perform parking braking on a vehicle;
detecting the electronic parking clamping force and a current state of the vehicle; and
adjusting, when detecting that the vehicle moves, the electronic parking clamping force according to a magnitude relationship between the electronic parking clamping force and the first preset value to perform the parking braking on the vehicle again.

2. The control method as claimed in claim 1, wherein adjusting the electronic parking clamping force according to the magnitude relationship between the electronic parking clamping force and the first preset value comprises:
when the electronic parking clamping force is smaller than the first preset value, adjusting the electronic parking clamping force to be equal to the first preset value.

3. The control method as claimed in claim 1, wherein adjusting the electronic parking, clamping force according to the magnitude relationship between the electronic parking clamping force and the first preset value comprises:
when the electronic parking clamping force is equal to the first preset value, adjusting the electronic parking clamping force to be equal to a maximum clamping force.

4. The control method as claimed in claim 1, after controlling, when the electronic parking brake is started, the electronic parking clamping force to be equal to the first preset value to perform the parking braking on the vehicle, further comprising:
after the electronic parking brake system has been started for a preset time period, readjusting the electronic parking clamping force to be equal to the first preset value.

5. The control method as claimed in claim 1, when controlling, when the electronic parking brake is started, the electronic parking clamping force to be equal to the first preset value to perform the parking braking on the vehicle, further comprising:
detecting a temperature change value of a friction plate or a brake disc; and
when the temperature change value is greater than a preset, temperature value, adjusting the electronic parking clamping force to be equal to a second preset value, wherein the second preset value is greater than the first preset value.

6. An electronic parking, brake system, comprising one or more processors, configured to execute the following program units; a control unit, a vehicle state detection unit and a clamping force detection unit, wherein
the control unit is configured to control, when an electronic parking brake is started, an electronic parking clamping force to be equal to a first preset value to perform parking braking on a vehicle;
the vehicle state detection unit is configured to detect a current state of the vehicle;
the clamping force detection unit is configured to detect the electronic parking clamping force; and
the control unit is configured to adjust, when the vehicle state detection unit detects that the vehicle moves, the electronic parking clamping force according to a magnitude relationship between the electronic parking clamping force and the first preset value to perform the parking braking on the vehicle again.

7. The electronic parking brake system as claimed in claim 6, wherein the control unit is configured to adjust, when the electronic parking clamping force is smaller than the first preset value, the electronic parking clamping force to be equal to the first preset value.

8. The electronic parking brake system as claimed in claim 6, wherein the one or more processors are further configured to execute the following program unit: a timing unit, wherein
the timing unit is configured to start, when the electronic parking brake system is started, timing; and
the control unit is configured to readjust, when a time of the timing unit reaches a preset time, the electronic parking clamping force to be equal to the first preset value.

9. The electronic parking brake system as claimed in claim 6, wherein the one or more processors are further configured to execute the following program unit: a temperature detection unit, wherein
the temperature detection unit is configured to detect a temperature of a friction plate or a brake disc when the electronic parking brake system is started; and
the control unit is configured to readjust, when a temperature change value is greater than a preset temperature value, the electronic parking clamping force to be equal to a second preset value, wherein the second preset value is greater than the first preset value.

10. A vehicle, comprising the electronic parking brake system as claimed in claim 6.

11. The control method as <claimed in claim 1, wherein detecting the current state of the vehicle comprises:
detecting whether a wheel has a rotational motion or not by using a wheel speed sensor in the vehicle.

12. The control method as claimed in claim 1, wherein detecting the electronic parking clamping force comprises:
detecting the electronic parking clamping force by using a force sensor in the vehicle.

13. The control method as claimed in claim 5, wherein the second preset value is equal to a maximum clamping force.

14. The electronic parking brake system as claimed in claim 6, wherein the control unit is configured to adjust, when the electronic parking clamping force is equal to the first preset value, the electronic parking clamping force to be equal to a maximum clamping force.

15. The electronic parking brake system as claimed in claim 6, wherein the vehicle state detection unit is configured to detect the current state of the vehicle by detecting whether the vehicle is in a stationary state or a moving state.

16. The electronic parking brake system as claimed in claim 15, wherein the vehicle state detection unit is embodied as a wheel, speed sensor and is configured to detect the current state of the vehicle by detecting whether a wheel has a rotational motion.

17. The electronic parking brake system as claimed in claim 6, wherein the clamping force detection unit is embodied as a force sensor for detecting the electronic parking clamping force.

18. The electronic parking brake system as claimed in claim 9, wherein the second preset value is equal to a maximum clamping force.

19. A storage medium, in which a programming code is stored, wherein the programming code, when being executed, by a computing device, causes the computing device to execute the method as claimed in claim 1.

20. A computer program, comprising program codes which, when executed by a computing device, cause the computing device to implement the method as claimed in claim 1.
